(19) United States
(12) Patent Application Publication
(10) Pub. No.: US 2018/0080110 A1
(43) Pub. Date: Mar. 22, 2018

(54) ELIMINATION OF ZINC STAINING DURING HEAT TREATMENT PROCESSING OF ZINC CONTAINING FERROUS AND NON-FERROUS ALLOYS

(71) Applicants: Akin Malas, Gillette, NJ (US); Soren Wiberg, Ekero (SE)

(72) Inventors: Akin Malas, Gillette, NJ (US); Soren Wiberg, Ekero (SE)

(21) Appl. No.: 15/707,394

(22) Filed: Sep. 18, 2017

Related U.S. Application Data
(60) Provisional application No. 62/397,944, filed on Sep. 22, 2016.

(51) Int. Cl. C23C 2/06; C22C 18/02

(52) U.S. Cl. CPC C23C 2/06; C01B 3/00; C22C 18/02

(57) ABSTRACT

Methods and apparatus are provided for eliminating zinc staining during heat treatment of metals in a furnace having at least one furnace zone by providing a slightly oxidizing atmosphere in the at least one furnace zone. The methods and apparatus can be used, for example, for annealing metal alloys that contain zinc, wherein the occurrence of zinc evaporation is reduced or eliminated by the slightly oxidizing atmosphere.

### FIELD OF THE INVENTION

The present invention relates to improvements for the heat treatment of metals.

### BACKGROUND OF THE INVENTION

Annealing of metals is common. When the metal being annealed includes zinc, such as ferrous and non-ferrous alloys, including brass, the zinc is released from the alloy mixture by evaporation from the metal surface. This evaporation occurs at temperatures that are lower than the actual annealing temperature. The released zinc then reacts with free oxygen in the annealing atmosphere and forms three different types of residue, i.e. opaque white, grey and glitter.

The zinc reacts with the free oxygen to form zinc oxide particles having the three types noted above. These zinc particles may then stick to the metal surface being annealed, forming zinc spots. At least the portion of the product exhibiting such zinc spots is generally unusable and must be scrapped. The losses caused by zinc spots can be significant, e.g. up to 20% of the metal surface.

One method of avoiding the formation of zinc oxides is to reduce the heating zone, but this results in a reduction of production capacity of up to 40%.

There remains a need in the art for improvements to annealing of metals containing zinc.

### SUMMARY OF THE PRESENT INVENTION

The invention provides a method for annealing of metal alloys that contain zinc. The invention minimizes zinc evaporation by creating a slightly oxidizing atmosphere in the annealing oven at temperatures where zinc is evaporating.

### BRIEF DESCRIPTION OF THE DRAWINGS

For more complete understanding of the present invention, reference may be made to the following description taken in connection with the accompanying drawings, of which:

FIG. 1 shows a schematic view of an embodiment of the present invention; and

FIG. 2 shows a schematic view of another embodiment of the present invention.

### DETAILED DESCRIPTION OF THE INVENTION

The invention relates to a method for annealing of metal alloys that contain zinc. The evaporation of zinc is minimized by having a slightly oxidizing atmosphere in the annealing oven, particularly at the temperatures where the evaporation of zinc occurs.

Having an oxidizing atmosphere in the annealing oven prevents the zinc from diffusing to the atmosphere and therefore eliminates zinc spotting on the metal surface. In addition, zinc evaporation can be suppressed or eliminated with increased partial pressure. Therefore, according to the invention, furnace zones having increased pressure are created through the use of nozzle fields and high pressure gas nozzles. As described in more detail below, an annealing furnace having different zones is used. Each zone is separately controllable. This allows for different temperatures and atmospheric conditions to be established in the separate zones. In particular, different temperatures and atmospheres that are either oxidative or reducing in nature can be established in the different furnace zones. Coupled with the use of high pressure gas nozzle arrays, gas streams are used to establish pressurized that create a higher partial pressure at the metal surface. These parameters serve to reduce or eliminate the zinc evaporation and and zinc spotting of the metal surface.

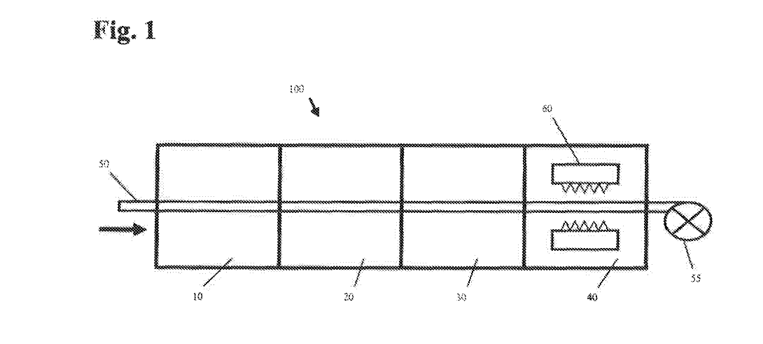

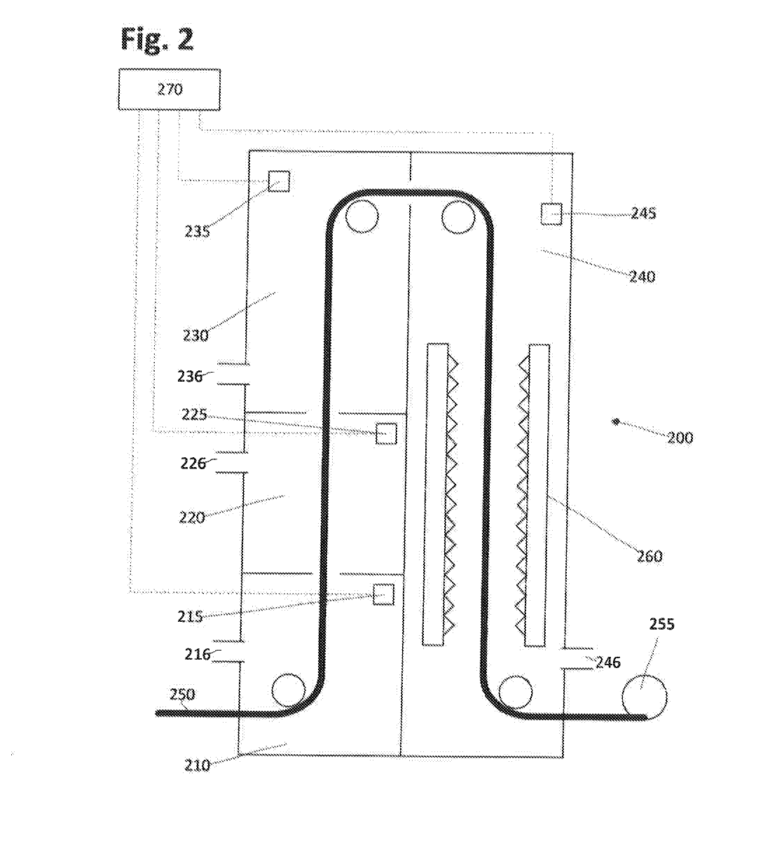

The invention will be explained in greater detail with reference to drawing FIGS. 1 and 2.

The drawing FIG. 1 schematically shows an annealing tunnel oven 100, that has four separate sections or zones, section 10, section 20, section 30 and section 40. A metal strip 50 to be annealed passes through each zone of the oven 100 and is stored in a coil 55 after annealing is complete. Each section contains its own gas analysis devices and a gas supply inlet. This allows for separate and individual control of the atmosphere conditions in each section. This control provides the means by which zinc spots can be eliminated.

The drawing FIG. 2 schematically shows another embodiment of the invention. A vertical tunnel furnace 200 is shown having a plurality of separate zones, in this embodiment for example four separate zones, i.e. zone 210, zone 220, zone 230 and zone 240. A brass sheet 250 to be annealed passes through each zone of the furnace 200 and is then stored in a coil 255. Each zone contains its own gas analysis devices 215, 225, 235, 245 connected to a control unit 270. Further, each zone 210, 220, 230, 240 is provided with a gas supply inlet 216, 226, 236, 246, respectively. This allows for separate and individual control of the atmosphere conditions in each zone. This control provides the means by which zinc spots can be eliminated.

An example of the conditions for each section of the annealing tunnel oven 100 or each zone for the vertical furnace 200 will be provided below, for the specific operation of annealing a brass sheet. The furnace may be of any standard configuration, such as a vertical tunnel furnace where heating starts at the bottom and proceeds to the top. The terms “section” and “zone” are used interchangeably herein.

The brass sheet enters the first section 10, 210, of the tunnel furnace 100, 200. In section 10, 210, the furnace temperature is between room temperature and 300° F., and the dew point temperature is between 00 to 10° F. The atmosphere in the first section 10, 210 is a wet nitrogen atmosphere.

After passing through section 10, 210, the brass sheet enters section 20, 220 where the furnace temperature is between 300° F. and 900° F., and the dew point temperature is between 0° F. and 20° F. The atmosphere in the second section 20, 220 is a 100% nitrogen atmosphere.

The brass sheet exits section 20, 220 and enters section 30, 230 where the furnace temperature is between 900° F. and 1900° F., and the dew point temperature of the furnace atmosphere is between 0° F. and −94° F. The atmosphere in the third section 30, 230 is a 100% hydrogen atmosphere.

Finally, the brass sheet enters section 40, 240, which is a cooling section with a furnace temperature between 1900° F. and room temperature, and an atmosphere dew point temperature between 0° F. and −35° F. The atmosphere in the fourth section 40, 240 is a 100% hydrogen atmosphere. The hydrogen supplied to the fourth section 40, 240 is provided at high pressure, e.g. 5-10 barg, through banks of impingement nozzles 60, 260. This provides a high pressure zone of 1-2 barg in the fourth section 40, 240.

The conditions in section 10, 210 and section 20, 220 are designed to have an oxidizing atmosphere that creates an oxide barrier and eliminates zinc evaporations. Section 10, 210 and section 20, 220 are each maintained as nitrogen atmospheres to provide the oxidizing conditions. Section 30, 230 has a reducing atmosphere, in this case a hydrogen atmosphere that achieves oxide removal and metal product annealing. Section 40, 240 provides the cooling atmosphere as well as a reducing atmosphere, again provided by a hydrogen atmosphere, while maintaining oxide free annealing that protects the metal surface brightness.

The invention provides a relatively simple and cost effective method of eliminating zinc evaporation during annealing of metals. This results in significantly less scrap or unusable product while retaining high production rates.

It is understood that other embodiments and variations of the present invention will become readily apparent to the skilled artisan in view of the foregoing description, and it is intended that such embodiments and variations be included within the scope of the invention as set forth in the appended claims.

What is claimed is:

1. A method of eliminating zinc staining during heat treatment of metals in a furnace having at least one furnace zone, comprising providing a slightly oxidizing atmosphere in the at least one furnace zone.

2. The method of claim 1, further comprising providing nozzles for increasing the pressure in the at least one furnace zone.

3. The method of claim 2, wherein the nozzles comprise high pressure gas nozzles.

4. The method of claim 2, wherein the increasing pressure comprises injecting a gas at high pressure into the at least one furnace zone.

5. The method of claim 4, wherein the high pressure is in a range of from 5-10 barg.

6. The method of claim 1, wherein the heat treatment comprises annealing of the metals.

7. The method of claim 1, wherein the furnace comprises at least two furnace zones; and further comprising separately controlling atmospheric conditions in each of the at least two furnace zones, the atmospheric conditions selected from the group consisting of temperature, pressure, and dew point.

8. The method of claim 1, wherein the metals comprise brass.

9. The method of claim 1, wherein the heat treatment comprises annealing of brass.

10. The method of claim 1, wherein the furnace comprises a vertical furnace.

11. The method of claim 1, wherein the slightly oxidizing atmosphere comprises wet nitrogen.

12. The method of claim 1, wherein the slightly oxidizing atmosphere has a dew point temperature of from between 0° F. and 20° F.

13. The method of claim 1, wherein the at least one furnace zone comprises a reducing atmosphere.

14. The method of claim 13, further comprising introducing hydrogen into the at least one furnace zone.

15. The method of claim 1, further comprising providing a cooling zone for the furnace, the cooling zone having a temperature in a range of between 1900° F. and room temperature, and a dew point temperature in a range of between 0° F. and −35° F.

16. The method of claim 15, wherein the cooling zone comprises a reducing atmosphere.
